(19) United States
(12) Patent Application Publication
(10) Pub. No.: US 2015/0213164 A1
(43) Pub. Date: Jul. 30, 2015

(54) PRODUCT DESIGN RELIABILITY WITH CONSIDERATION OF MATERIAL PROPERTY CHANGES DURING SERVICE

(71) Applicant: GM Global Technology Operations LLC, Detroit, MI (US)

(72) Inventors: Qigui Wang, Rochester Hills, MI (US); Devin R. Hess, Burton, MI (US); Michael J. Walker, Shelby Township, MI (US); Herbert W. Doty, Fenton, MI (US); Bowang Xiao, Auburn Hills, MI (US)

(73) Assignee: GM Global Technology Operations LLC, Detroit, MI (US)

(21) Appl. No.: 14/164,613

(22) Filed: Jan. 27, 2014

(51) Int. Cl. G06F 17/50

(52) U.S. Cl. CPC G06F 17/5018

(57) ABSTRACT

A method of computationally determining material property changes for a cast aluminum alloy component. Accuracy of the determination is achieved by taking into consideration material property changes over the projected service life of the component. In one form, the method includes accepting time-dependent temperature data and using that data in conjunction with one or more constitutive relationships to quantify the impact of various temperature regimes or conditions on the properties of heat-treatable components and alloys. Finite element nodal analyses may be used as part of the method to map the calculated material properties on a nodal basis, while a viscoplastic model may be used to determine precipitation hardening and softening effects as a way to simulate the time and temperature dependencies of the material. The combined approach may be used to determine the material properties over the expected service life of a cast component made from such material.

### BACKGROUND OF THE INVENTION

The present invention relates generally to a material property change during service of a cast component, and in particular to improved product design reliability and durability analysis accuracy by taking into consideration material property changes during the projected service life of the cast component.

The most common Al—Si based alloys used in making cast automotive engine blocks and cylinder heads are heat treatable variants, including alloy 319 (nominal composition by weight: 6.5% Si, 0.5% Fe, 0.3% Mn, 3.5% Cu, 0.4% Mg, 1.0% Zn, 0.15% Ti and balance Al) and alloy 356 (nominal composition by weight: 7.0% Si, 0.1% Fe, 0.01% Mn, 0.05% Cu, 0.3% Mg, 0.05% Zn, 0.15% Ti, and balance Al). Aluminum alloys like 319 and 356 are usually heat treated to T6 or T7 conditions before use by subjecting them to three main stages: (1) solution treatment at a relatively high temperature below the melting point of the alloy, often for times exceeding 8 hours or more to dissolve its alloying (solute) elements and homogenize or modify the microstructure; (2) rapid cooling, or quenching, such as by cold or hot water, forced air or the like, to retain the solute elements in a supersaturated solid solution (where these two steps are also defined as T4); and (3) artificial aging (T5, which is aging without solution treatment) by holding the alloy for a period of time at an intermediate temperature suitable for achieving hardening or strengthening through precipitation. The T4 solution treatment serves three main purposes: (1) dissolution of elements that will later cause age hardening; (2) spherodization of undissolved constituents; and (3) homogenization of solute concentrations in the material. The post-T4 quenching is used to retain the solute elements in a supersaturated solid solution (SSS) and also to create a supersaturation of vacancies that enhance the diffusion and the dispersion of precipitates, while aging (either the natural or T5 artificial variant) creates a controlled dispersion of strengthening precipitates.

Components made from heat-treated aluminum-based castings (such as turbocharger housings in addition to the aforementioned cylinder heads and engine blocks) change properties during service due to thermal effects. In fact, in-service property changes can significantly alter the ability to predict component life and reliability, where such post-manufacturing material property change is not considered in current product design and durability analysis methods. In one example, engine blocks and particularly cylinder heads made of such aluminum alloys may be subjected to age hardening or softening during engine operation such that they experience thermal mechanical fatigue (TMF) over time in service. This problem is especially acute in high performance engine applications where exposure to elevated temperatures (such as due to its proximity to exhaust gas, oil, coolant or the like) is encountered. Present durability analysis and life prediction (such as fatigue analysis or related life prediction) of cast components methods often resort to making simplifying assumptions—such as constant material properties—that in fact don't represent these material property changes that take place over time; analyses based on such assumptions are subject to inaccuracies as the component in-service time lengthens.

### SUMMARY OF THE INVENTION

One aspect of the invention involves a method to determine in-service material property changes to cast aluminum components by incorporating non-uniform transient (i.e., time-dependent) temperature distributions of the cast component during its service life into nonlinear heat treatable aluminum casting constitutive behavior. In the present invention, the conventional constitutive model (which only considers strain and thermal (creep) effects) is augmented by a viscoplastic model that includes time-dependent material property changes that take into consideration precipitation hardening and softening that can be expected to occur in a component that is subjected to high temperatures for a long time during its in-service life. By the present invention, these prolonged high temperature conditions of a heat-treated material can be accurately modeled through a simulation of a substantially continuous aging process associated with such long-term operation of the component.

The in-service transient temperature distribution can be calculated using solid mechanics discretization techniques, such as finite element analysis (FEA) based on component service conditions, while the nonlinear constitutive behavior may be modeled as a function of temperatures, time, microstructure variations and even strain rate. A material constitutive model (which describes macroscopic behavior resulting from the internal constitution of the material) establishes a relation between quantities that are particular to a given alloy as a way to predict the response of a component using such alloy to applied loads. Such a model may be thought of as a formulation of separate equations to describe an idealized material response as a way to approximate physical observations associated with the response of the actual material. By way of example, the constitutive model accounts for not only strain hardening and creep, but also precipitate hardening or softening. Significantly, such an approach can help improve product durability analysis accuracy, improve product design robustness and reduce product design iterations, analysis cost and part warranty cost.

The quantified time and temperature-dependent nodal material property values are preferably put into a user-ready format, such as a printout suitable for human reading or viewing, or data in computer-readable format that can be subsequently operated upon by a computer-readable algorithm (such as for additional analytical investigation or determination), computer printout device or other suitable means.

### BRIEF DESCRIPTION OF THE DRAWINGS

The following detailed description of the present invention can be best understood when read in conjunction with the following drawings, where like structure is indicated with like reference numerals and in which:

FIG. 1 shows a typical heat treatment cycle of an aluminum alloy according to the prior art;

FIG. 2 shows an example of yield strength as an aging response of cast alloys 319 aged at 200° C., 240° C. and 260° C.; respectively.

FIG. 3 shows a block diagram of a product service durability analysis with consideration of material property changes during service;

FIG. 4 shows a computerized system that can be used to measure and quantify in-service material property changes of a cast aluminum alloy component according to an aspect of the present invention;

FIG. 5 shows a comparison of experimental stress-strain curves with material constitutive model predictions for the analysis of FIG. 3;

FIG. 6 shows a flow chart of a user-defined material property subroutine as used in a nodal-based finite element analysis;

FIG. 7 shows a comparison of experimentally measured and model-predicted monotonic stress-strain curves for cast aluminum alloy A356;

FIG. 8 shows a comparison of experimentally measured and model-predicted hysteresis curves for cast aluminum alloy A356; and

FIG. 9 shows a stress-strain diagram highlighting compressive and tensile loads, as well as linear and nonlinear response for an aluminum alloy.

### DETAILED DESCRIPTION OF THE PREFERRED EMBODIMENTS

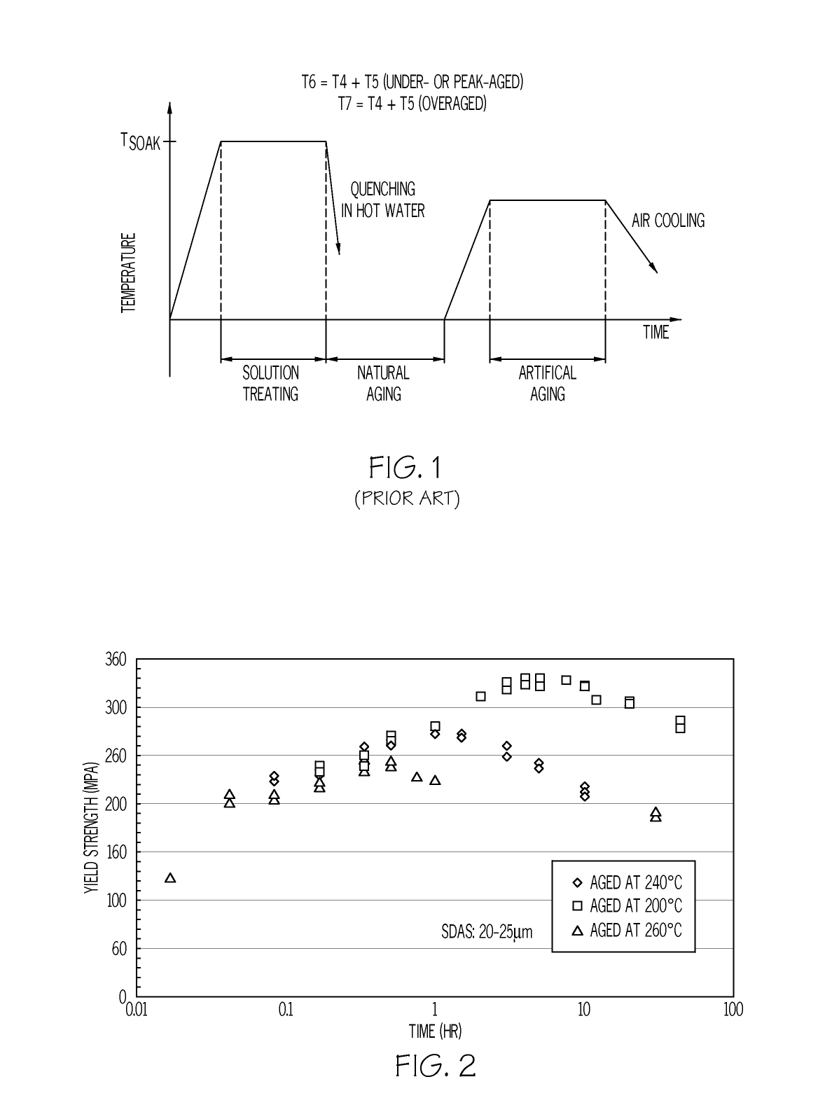

Referring first to FIG. 1, a typical T6 and/or T7 heat treatment cycle of an aluminum alloy according to the prior art is shown. In T5 aging, there are three types of aging conditions, commonly referred as (1) underaging, (2) peak aging and (3) overaging. At an initial stage of the aging, GP zones and fine shearable precipitates form and the structure is considered as underaged. At this stage, the material hardness and yield strength are usually low. Increased time at a given temperature or aging at a higher temperature further evolves the precipitate structure, hardness and yield strength increase to a maximum, the peak aging/hardness condition. Further aging decreases the hardness/yield strength and the structure becomes overaged due to precipitate coarsening and its transformation of crystallographic incoherency.

Referring next to FIG. 2, an example of aging responses of cast aluminum alloy 319 aged at various temperatures is shown. For the period of aging time tested at giving aging temperature, the alloys undergo underaged, peak aged, and overaged stages. As shown in the figure, materials properties (in particular tensile properties) change with time at a given temperature. This means that the properties of aluminum castings are changing during component service, particularly when elevated temperature is present. This post-manufacturing material property change needs to be included in product design and durability analyses, as present assumptions of constant material properties during service or testing can lead to over-prediction or under-prediction of component life. In particular, the post-manufacturing material property changes during part service may be predicted through incorporating non-uniform transient temperature distribution of the casting during service with the nonlinear constitutive behavior of heat treatable microstructures of aluminum castings. More particularly, the transient temperature distribution of the aluminum casting during service may be calculated based on part service conditions. The plot shows the aging response of cast aluminum alloys 319 is shown (although comparable trends may be seen in other alloys such as A356 and A357. Furthermore, although shown as a relationship between tensile yield strength and aging temperature and time, it will be appreciated by those skilled in the art that it could also be shown as the hardness as a function of aging time,

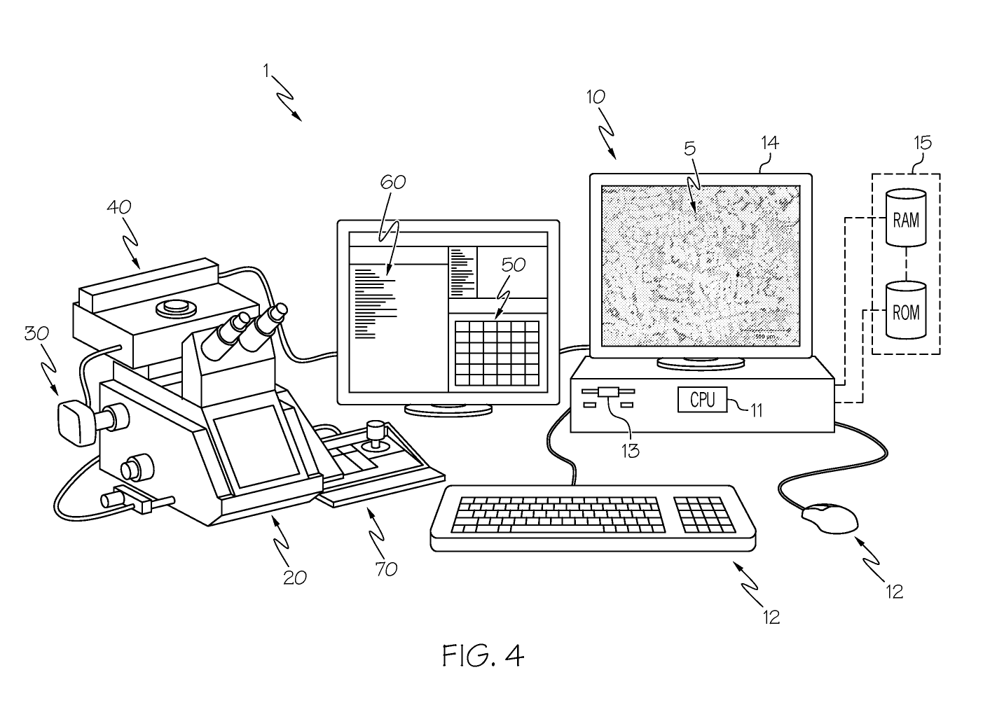

Referring next to FIG. 4, a way to measure and predict material property changes of a cast aluminum alloy component on a digital computer system 1 or related electronic device is shown. In situations where system 1 is computer-based in the manner discussed below (as well as suitable variants thereof), it is referred to as having a von Neumann architecture. Likewise, a particularly-adapted computer or computer-related data processing device that employs the salient features of such an architecture in order to perform at least some of the data acquisition, manipulation or related computational functions, is deemed to be compatible with the method of the present invention. It will be appreciated by those skilled in the art that computer-executable instructions that embody the calculations discussed elsewhere in this disclosure can be made to achieve the objectives set forth in the present invention.

System 1 includes a computer 10 or related data processing equipment that includes a processing unit 11 (which may be in the form of one or more microprocessors or related processing means), one or more mechanisms for information input 12 (including a keyboard, mouse or other device, such as a voice-recognition receiver (not shown)), as well as one or more loaders 13 (which may be in the form of magnetic or optical memory or related storage in the form of CDs, DVDs, USB port or the like), one or more display screens or related information output 14, a memory 15 and computer-readable program code means (not shown) to process at least a portion of the received information relating to the aluminum alloy. As will be appreciated by those skilled in the art, memory 15 may be in the form of random-access memory (RAM, also called mass memory, which can be used for the temporary storage of data) and instruction-storing memory in the form of read-only memory (ROM). In addition to other forms of input not shown (such as through an internet or related connection to an outside source of data), the loaders 13 may serve as a way to load data or program instructions from one computer-usable medium (such as flash drives or the aforementioned CDs, DVDs or related media) to another (such as memory 15). As will be appreciated by those skilled in the art, computer 10 may exist as an autonomous (i.e., stand-alone) unit, or may be the part of a larger network such as those encountered in cloud computing, where various computation, software, data access and storage services may reside in disparate physical locations. Such a dissociation of the computational resources does not detract from such a system being categorized as a computer.

In a particular form, the computer-readable program code that contains the algorithms and formulae mentioned above can be loaded into RAM that is part of memory 15. Such computer-readable program code may also be formed as part of an article of manufacture such that the instructions contained in the code are situated on a magnetically-readable or optically-readable disk or other related non-transitory, machine-readable medium, such as flash memory device, CDs, DVDs, EEPROMs, floppy disks or other such medium capable of storing machine-executable instructions and data structures. Such a medium is capable of being accessed by computer 10 or other electronic device having processing unit 11 used for interpreting instructions from the computer-readable program code. Together, the processor 11 and any program code configured to be executed by the processor 11 define a means to perform one or more of the precipitate size and distribution as well as materials constitutive behavior calculations discussed herein. As will be understood by those skilled in the computer art, a computer 10 that forms a part of computer aided engineering system 1 may additionally include additional chipsets, as well as a bus and related wiring for conveying data and related information between processing unit 11 and other devices (such as the aforementioned input, output and memory devices). Upon having the program code means loaded into RAM, the computer 10 of system 1 becomes a specific-purpose machine configured to determine time-dependent material properties in a manner as described herein. In another aspect, system 1 may be just the instruction code (including that of the various program modules (not shown)), while in still another aspect, system 1 may include both the instruction code and a computer-readable medium such as mentioned above.

It will also be appreciated by those skilled in the art that there are other ways to receive data and related information besides the manual input approach depicted in input 12 (especially in situations where large amounts of data are being input), and that any conventional means for providing such data in order to allow processing unit 11 to operate on it is within the scope of the present invention. As such, input 12 may also be in the form of high-throughput data line (including the internet connection mentioned above) in order to accept large amounts of code, input data or other information into memory 15. The information output 14 is configured to convey information relating to the desired casting approach to a user (when, for example, the information output 14 is in the form of a screen as shown) or to another program or model; all such forms are deemed to be in user-ready format so long as they are in a form that can be viewed and understood by a human user, or otherwise made available as a structured data format for subsequent analysis or processing in a computational algorithm or related programming routine. It will likewise be appreciated by those skilled in the art that the features associated with the input 12 and output 14 may be combined into a single functional unit such as a graphical user interface (GUI).

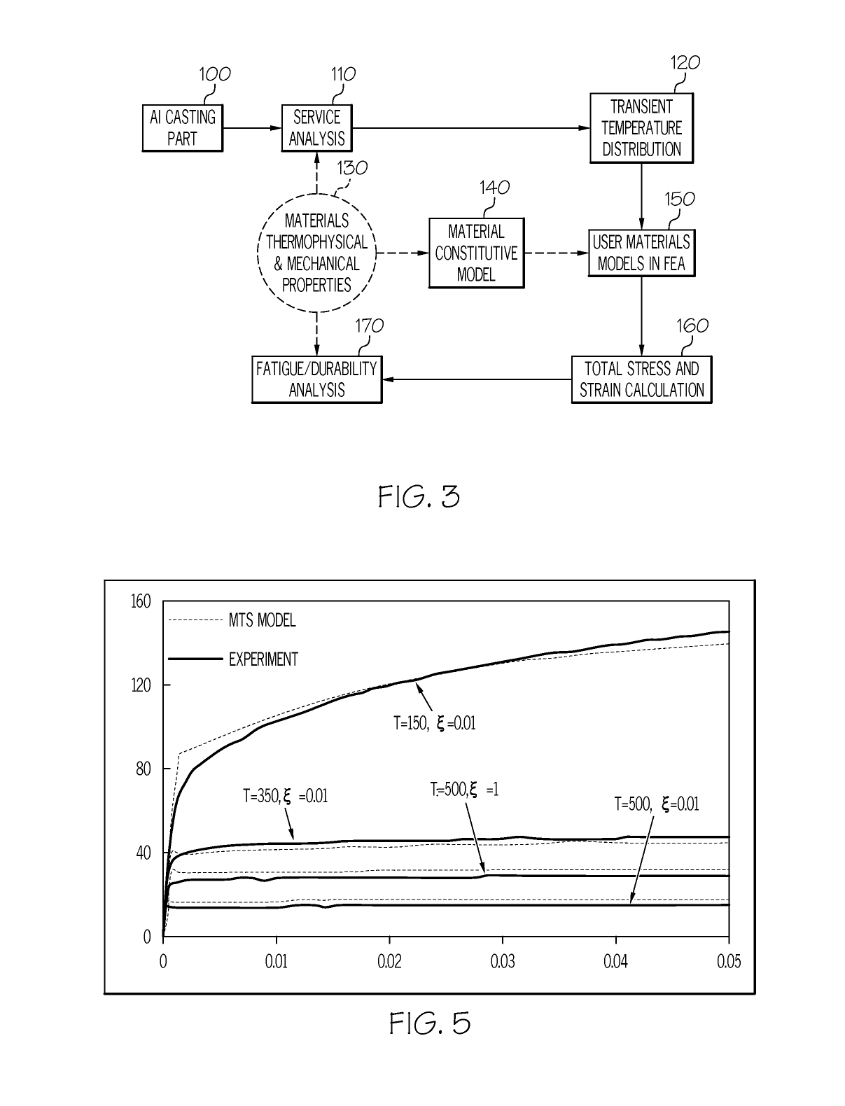

Referring next to FIG. 3 in conjunction with FIG. 4, a block diagram shows an aspect of the present invention where the modeling strategy and procedures of durability analysis with consideration of materials property change during service. As stated above, these material property changes may be predicted by (a) incorporating non-uniform transient temperature distributions over the service life of the component with (b) nonlinear constitutive behavior of the heat treatable microstructures of the aluminum castings. In addition to thermal history and stress state, these changes of material properties during component service life have significant impact on component performance. The modeling (which can be conducted on system 1 of FIG. 4 above) includes providing geometric modeling data 100 (for example, a computer-aided design (CAD) or related nodal-based file) of the aluminum alloy part or component to be cast. From this, data 110 pertaining to an analysis of the expected service load and conditions of the component are provided. Furthermore, data 120 corresponding to expected transient temperature distributions that the component will encounter over its service life is included, while material thermophysical and mechanical properties data 130 is also provided. The thermophysical and mechanical properties data 130 is fed into a material constitutive model 140 which is in turn coupled with the expected transient temperature distribution data 120 so that macroscopic response of the component defined by the geometric modeling data 100 can be determined based on the imposed time, temperature and related service life-based factors. In one form, the coupling of the material constitutive model 140 and the data 100, 110, 120 and 130 can be fed into an FEA user-defined materials model 150 that in turn is used as part of a stress and strain calculation 160. After the stress and strain are calculated at any given time, the results can be fed (along with the thermophysical and mechanical properties data 130) into a component-level fatigue and durability analysis 170 to provide a prediction of expected component behavior based on time and temperature dependent material data.

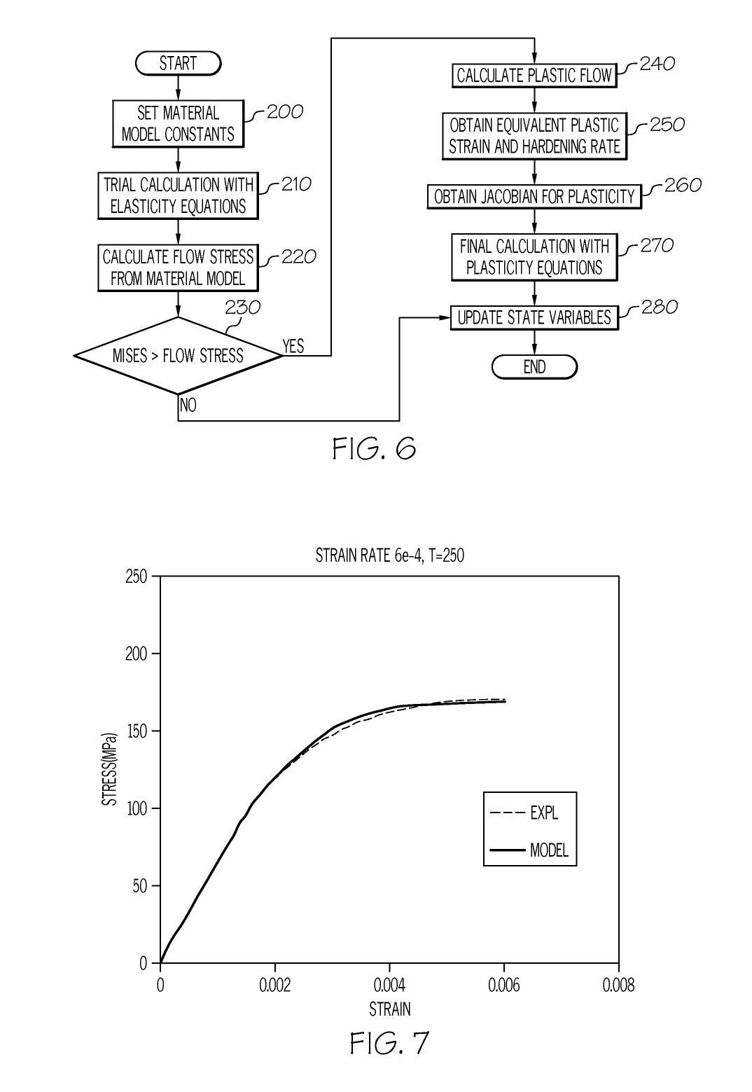

In general, the present invention solves a set of discretized partial differential equations, and in particular uses time and temperature dependent material data rather than just temperature dependent data. As such, information generated in the present invention differs from traditional iterative approaches to get a best solution in that it conducts a continuous analysis of the component or system during a period of time or a number of cycles that correspond to the component's service life. Particular forms of solid mechanics discretization techniques, such as the material constitutive model 140 and the FEA user-defined materials model 150, may be loaded into memory 15 as computer-readable program code for operation upon by processing unit 11 in order to perform one or more algorithmic calculations. As such, FIG. 3 represents a flow chart for a substantially complete durability analysis based on these updated data considerations, while that of FIG. 6 (which will be discussed in more detail below), only deals with one of FIG. 3's steps (in particular, the “User Materials Models in FEA” step 150). In fact, FIG. 6 shows with more detail the completion of step 150.

Referring next to FIGS. 6 through 8 and regarding the constitutive behavior first, one way to model such behavior is to develop empirical or semi-empirical equations from experimental stress-strain curves for different temperatures, time, strain rates and microstructures. As an example, the two equations that follow are the Ludwik and the modified Ludwik semi-empirical models, respectively. Each of these equations has a number of material dependent parameters which must be determined based on experimental measurements and these parameters (e.g., “K”, “m” and “n”) typically will vary as a function of temperature and alloy composition and microstructures.

$$σ = K {{ɛ}_{p}^{n} ( \frac{{\dot{ɛ}}_{p}}{{ɛ}_{o}} )}^{m}$$

$$σ = {K ( {ɛ}_{p} + {ɛ}_{{p}_{o}} )}^{n} {( {\dot{ɛ}}_{p} + {\dot{ɛ}}_{{p}_{o}} )}^{m}$$

where σ is the stress (MPa) at some plastic strain εₚ beyond the yield point, K is a material strength constant, n is the strain hardening coefficient, \dot{ε}ₚ is the plastic strain rate (s−1), εₒ is a constant, m is the strain rate sensitivity coefficient, and εₚ is the total plastic strain accumulated by the material at temperatures below 400 ° C. (above which temperature it is assumed that no strain hardening occurs, and the flow stress is purely dependent on temperature and strain rate). The two coefficients \dot{ε}ₚ₀=1×10⁻⁴ and εₚₒ=1×10⁻⁶ are determined experimentally.

Another approach is to employ viscoplastic constitutive models. A first type of viscoplastic model that only considers plastic hardening corresponds to Eqns. 1 through 5 below. A second type of viscoplastic model—which includes thermal strain effects—corresponds to Eqns. 6 through 8 below, while a third type is a modified MTS model that corresponds to Eqns. 9 through 12 below, which adds precipitation hardening/softening to represent the material property change during service of the respective component. Unlike simple equations for ideal materials (such as Newtonian/viscous fluids—where stress depends on the rate of deformation—at one end of the idealized material spectrum or Hookean/elastic solids—where stress depends on the strain—at the other end of the idealized material spectrum), constitutive equations for more complex materials may take into consideration plasticity, viscoelasticity and viscoplasticity as a way to address the analytical needs associated with a time-dependent material (such as cast aluminum alloys) that exist somewhere in-between. With particular regard to viscoplastic materials (with their ability to withstand a shear stress up to a point), a unified viscoplastic model can be expressed as:

$${\dot{ɛ}}_{ij}^{in} = f ( \overline{σ} , R , K ) \sqrt{\frac{3}{2}} \frac{{S}_{ij} - {α}_{ij}}{\overline{σ}} \qquad ( 1 )$$

where work-hardening assumptions to account for changes in properties (such as yield functions) in response to plastic deformation may be expressed in various ways. For example, kinematic hardening

$$\begin{matrix}{α}_{ij} = {\sum }_{k = 1}^{m} {α}_{mij} & ( 2 ) \\ {\dot{α}}_{mij} = {C}_{m} {\dot{ɛ}}_{ij}^{in} - {r}^{D} ( \overline{α} , \dot{p} , {h}_{m} ) \dot{p} {α}_{mij} - {r}^{s} ( \overline{α} , \dot{p} , {h}_{m} ) {α}_{mij} & ( 3 )\end{matrix}$$

and isotropic hardening (where the yield surface maintains its shape while the size increase is controlled by a single parameter depending on the degree of plastic deformation)

\dot{R}=f(R,h_{α})\dot{p}−f_{rd}(R,h₆₀)R−f_{rd}(R,h_{α}) (4)

may be considered to be two forms of such simplifying assumptions. Likewise, the drag stress evolution

\dot{K}=φ(K,h_{α})\dot{p}−φ_{rd}(K,h_{α})K−φᵣₛ(K,h_{α}) (5)

is used to quantify the drag stress induced by material internal friction resistance. In general, the drag stress is part of viscoplastic model; what the present inventors have discovered is that inclusion of precipitation hardening (i.e., the third term on the right side of Eqn. 9 below) helps to provide more accuracy to the calculation.

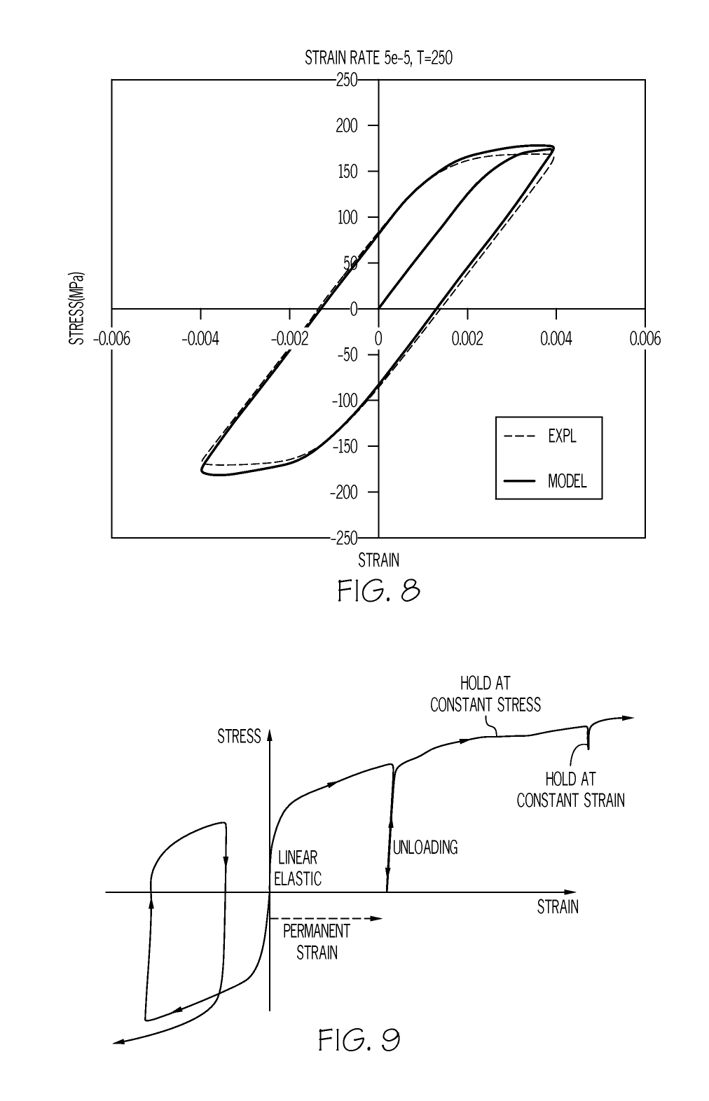

To that end, some background discussion on isotropic and kinematic hardening (as well as the inelastic response of metals) helps explain the features of the present invention in more detail. Regarding the inelastic response of metals first, in general, the results of a typical tension/compression test on an annealed, ductile, polycrystalline metal specimen (such as Cu or Al) could be based on the assumption that the test is conducted at moderate temperature (for example, at room temperature, which may be less than half the material's melting point) and at modest strains (for example, less than 10%), as well as at modest strain rates (for example, 10 to 1/100 per second), An exemplary form of such a response is shown in FIG. 9. The results of such a test are that for modest stresses (and strains) the solid responds elastically such that the attendant proportionality of the stress and strain implies that the deformation is reversible. Contrarily, if the stress exceeds a critical magnitude, the stress-strain curve ceases to be linear; under such conditions, it is often difficult to identify the critical stress accurately. Moreover, if the critical stress is exceeded, the specimen is permanently changed in length on unloading. If the stress is removed from the specimen during a test, the stress strain curve during unloading has a slope equal to that of the elastic part of the stress strain curve. If the specimen is re-loaded, it will initially follow the same curve, until the stress approaches its maximum value during prior loading. At this point, the stress strain curve once again ceases to be linear, and the specimen is permanently deformed further. If the test is interrupted and the specimen is held at constant strain for a period of time, the stress will relax slowly. If the straining is resumed, the specimen will behave as though the solid were unloaded elastically. Similarly, if the specimen is subjected to a constant stress, it will generally continue to deform plastically, although the plastic strain increases very slowly in what was mentioned above as creep. Furthermore, if the specimen is deformed in compression for modest strain levels, the stress-strain curve is a mirror image of the tensile stress strain curve, whereas for large strains, geometry changes will cause differences between the tension and compression tests. Additionally, if the specimen is first deformed in compression, then loaded in tension, it will generally start to deform plastically at a lower tensile stress than an annealed specimen. This phenomenon is known as the Bauschinger effect. The example depicted in the figure shows that a material's response to cyclic loading can be extremely complex, and also shows that the plastic stress-strain curve depends on the rate of loading, as web as on the temperature.

Regarding the isotropic and kinematic hardening, if a solid material is plastically deformed via loading and unloading, and then reloaded as a way to induce further plastic flow, its resistance to such plastic flow will have increased. In other words, its yield point/elastic limit increases, meaning that plastic flow begins at a higher stress than in the previous cycle. This phenomenon is known as strain hardening, which can be PEA modeled in a couple of different ways (one of which is achieved by isotropic hardening, and the other by kinematic hardening). For isotropic hardening, the process of plastically deforming a solid, then unloading it, then attempting to reload it again will show signs of increasing yield stress or elastic limit) compared to what it was in the first cycle. Subsequent repetition would show further increases as long as each reload is past its previously reached maximum stress; such reloading may continue until a stage (or a cycle) is reached that the solid deforms elastically throughout. In essence, isotropic hardening means that a material will not yield in compression until it reaches the level past yield that which was attained when it was loaded in tension. Thus, if the yield stress in tension increases due to hardening, the compression yield stress grows the same amount even though the specimen may not have been loaded in compression. This type of hardening is useful in PEA models to describe plasticity, but not used in situations where components are subjected to cyclic loading. Isotropic hardening does not account for the aforementioned Bauschinger effect and predicts that after a few cycles, the solid material will just harden until it responds elastically. Because actual metals exhibit some isotropic hardening and some kinematic hardening, a way is needed to correct for kinematic hardening effects, where the cyclic softening of the material takes place in compression and thus can correctly model cyclic behavior and the Bauschinger effect. In cyclic softening, the material gets soft after certain number of cycles, and is generally attributed to micro damage of the second phase particles. Likewise, thermal exposure may be used to simulate the situation when the material is subject to high temperature during service, while phase transformation is the continuous aging during service for heat-treatable materials like aluminum alloys, and microstructure variations indicates that the model coefficients are calibrated with different types of microstructure, such as fine and coarse microstructures.

With that overview of the inelastic response of metals, as well as isotropic and kinematic hardening, metal plasticity involves the assumption that the plastic strain increment and deviatoric stress tensor have the same principal directions; this assumption is encapsulated in a relation called the flow rule. In it, the thermo-viscoelastic materials constitutive model correlates the rule to a drag stress evolution factor and a back stress evolution factor, where the drag stress is similar to isotropic hardening in monotonic tension, which accounts for cyclic hardening or softening, and the influence of plasticity on creep or vice versa. Likewise, the back stress is similar to kinematic hardening in monotonic tension, and is used to predict the Bauschinger effect in room temperature loading, as well as the transient and steady-state creep response at high temperature. The equations above are recast from the above as follows, where the first includes the flow rule:

$${\dot{ɛ}}_{ij} = \text{?} + {\dot{ɛ}}_{ij}^{in} + \text{?} \\ {\dot{ɛ}}_{ij}^{in} = Af ( \frac{\overline{σ}}{K} ) \text{?} \\ \begin{matrix}f ( \frac{\overline{σ}}{K} ) = ( \frac{\overline{σ}}{K} ) \text{?} & when ( \frac{\overline{σ}}{K} ) \text{?} \\ f ( \frac{\overline{σ}}{K} ) = exp [ ( \frac{\overline{σ}}{K} ) \text{?} - 1 ] & when ( \frac{\overline{σ}}{K} ) \text{?}\end{matrix} \\ \text{?} \text{indicates text missing or illegible when filed} \qquad ( 6 )$$

The second shows the drag stress evolution:

$$\text{?} = \text{?} ( \frac{L}{{L}_{0}} ) \text{?} + θ \text{?} \\ \text{?} \text{indicates text missing or illegible when filed} \qquad ( 7 )$$

and the third shows the back stress evolution:

$$\text{?} = c ( \text{?} ) - \text{?} \\ \text{?} \text{indicates text missing or illegible when filed} \qquad ( 8 )$$

Referring with particularity to FIGS. 7 and 8, stress-strain curves for a sample evaluation are shown to compare experimentally measured materials properties under monotonic tension (FIG. 7) and cyclic loading (FIG. 8) with model predictions based on Eqns. 6 through 8.

The evolution equations for the kinematic (Eqns. 2 and 3), isotropic (Eqn. 4) and drag stress (Eqn. 5) generally include three parts: the hardening term, the dynamic recovery term and the static recovery term. While most viscoplastic models can describe the time-dependent cyclic inelastic deformation (including the strain rate sensitivity and the dwell time effect), they cannot represent the cyclic thermal-mechanical inelastic deformation behavior, impact of unusual amount of cyclic softening, thermal exposure (including phase transformation) and microstructure variations.

According to the present invention, the total strain is divided into elastic, plastic, creep and other strains due to thermal exposure of heat-treatable cast aluminum alloys. The plastic strain is described by time-independent plastic model while the creep strain is characterized by creep law. As discussed above, various constitutive models including empirical/semi-empirical models and viscoplastic constitutive models may be used to model material behavior, where the viscoplastic constitutive models may further include variants with strain hardening only, strain and thermal hardening/softening models and precipitation hardening/softening models; the present inventors have found this last variant (which is described according to the equations and discussion below) to be particularly useful. In particular, a precipitate hardening/softening model takes into consideration thermal strain due to phase transformation; this is described by.

$$\frac{σ}{μ ( T )} = {C}_{e} ( \dot{ɛ} , T ) \frac{{\hat{σ}}_{e}}{{μ}_{0}} + {C}_{p} ( \dot{ɛ} , T ) \frac{{\hat{σ}}_{p}}{{μ}_{0}} + {C}_{ppt} ( \dot{ɛ} , T ) \frac{{\hat{σ}}_{ppt}}{{μ}_{0}} \qquad ( 9 )$$

where Cₑ(\dot{ε},T), Cₚ(\dot{ε},T), and Cₚₚₜ(\dot{ε},T) are referred to as velocity (i.e., strain-rate)-modified temperature-dependent coefficients for intrinsic strength, strain hardening, and precipitation hardening, respectively; T is measured in Kelvin; μ₀=28.815 GPa is the reference value at 0 K and \dot{ε}=10⁷ s⁻¹ for cast aluminum; and μ(T) is the temperature-dependent shear modulus, given as

$$μ ( T ) = {μ}_{0} - \frac{3440}{exp ( \frac{215}{T} ) - 1} \qquad ( 10 )$$

Thus, in the present invention, the material property changes that take place over the projected service life of the cast component overcomes the limitation of known viscoplastic models through the addition of the third term in Eqn. 9. Because the third term of Eqn. 9 above takes into consideration precipitation hardening, the equation can account for material property changes that occur during the service life of the component.

Before yield, the stress-strain curve is treated in this model as being fully elastic, depending only on the Young's Modulus E and yield stress σ_{y}, where the former (in MPa) is determined from the stress-strain curves of tensile tests at different temperatures (in Kelvin) and strain rates using the following second-order polynomial.

E=67,599+72.353T−0.14767T² (11)

At yield, \hat{σ}ₚ=0, and the yielding stress σ_{y} depends only on the intrinsic strength \hat{σ}ₑ, scaled by Cₑ(\dot{ε},T). Likewise, after yield, the flow stress is modeled through the evolution of \hat{σ}ₚ and \hat{σ}ₚₚₜ, where preferably, a linear form is used for strain hardening.

$${\hat{σ}}_{p} = {\hat{σ}}_{p}^{′} + \frac{μ ( T )}{{μ}_{0}} {θ}_{0} [ 1 - \frac{{\hat{σ}}_{p}^{′}}{{\hat{σ}}_{os}} ] d ɛ \qquad ( 12 )$$

In the above, θ₀ represents the slope of the stress-strain curve at yield in the reference state (0 K, \dot{ε}=10⁷ s⁻¹) and \hat{σ}ₒₛ is a material parameter. The precipitation hardening can be described as:

$${\hat{σ}}_{ppt} = \frac{M}{b} \frac{{\int }_{0}^{∞} f ( {r}_{eq} ) F ( {r}_{eq} ) d {r}_{eq}}{{\int }_{0}^{∞} f ( l ) d l} \qquad ( 13 )$$

where M is the Taylor factor, b is the Burgers vector, r_{eq} and l are precipitate equivalent circle radius (r_{eq}=0.5d_{eq}) and spacing on the dislocation line, respectively. Furthermore, f(r_{eq}) is the precipitate size distribution, f(l) is the particle spacing distribution and F(r_{eq}) is the obstacle strength of a precipitate of radius r_{eq}. The Burgers vector b represents the magnitude and direction of the lattice distortion of dislocation in a crystal lattice, and is equal to 2.86×10⁻¹⁰ m for an aluminum alloy. Thus, when the material is continuously subject to aging during component service, the present inventors have discovered that the inclusion of a variable material property term in the constitutive model to take into consideration these precipitation hardening or softening effects significantly improves the accuracy of component mechanical property behavior calculations.

Assuming solute concentrations are constant as stated above, only two length scales (l and r_{eq}) of precipitate distribution affect the materials strength. These two length scales are related to the age hardening process and are functions of aging temperature (T) and aging time (t). Therefore, Eqn. (4) can be rewritten to a general form:

$${Δσ}_{ppt} = \frac{M}{b} {\int }_{0}^{Tc} {\int }_{0}^{∞} f ( T , t ) d t d T \qquad ( 14 )$$

The two length scales of precipitate distribution (l and r_{eq}) can be obtained empirically from experimental measurements or by computational thermodynamics and kinetics. In the present invention, the model is theoretically based on the fundamental nucleation and growth theories. The driving force (per mole of solute atom) for precipitation is calculated using:

$$Δ G = \frac{RT}{{V}_{atom}} [ {C}_{p} ln ( \frac{{C}_{0}}{{C}_{eq}} ) + ( 1 - {C}_{p} ) ln ( \frac{1 - {C}_{0}}{1 - {C}_{eq}} ) ] \qquad ( 15 )$$

where Vₐₜₒₘ is the atomic volume (m³mol⁻¹), R is the universal gas constant (8.314 J/K mol), T is the temperature (K), C₀, C_{eq}, and Cₚ are mean solute concentrations by atom percentage in matrix, equilibrium precipitate-matrix interface, and precipitates, respectively. From the driving force, a critical radius r_{eq}* is derived for the precipitates at a given matrix concentration C:

$${r}_{eq} *= \frac{2 γ {V}_{atom}}{Δ G} \qquad ( 16 )$$

where γ is the particle/matrix interfacial energy.

The variation of the precipitate density (number of precipitates per unit volume) is given by the nucleation rate. The evolution of the mean precipitate size (radius) is given by the combination of the growth of existing precipitates and the addition of new precipitates at the critical nucleation radius r_{eq}*. The nucleation rate is calculated using a standard Becker-Doring law:

$${\frac{d N}{d t} \vert}_{nucleation} = {N}_{0} Z β * exp ( - \frac{4 π {r}_{0}^{2} γ}{3 RT {ln}^{2} ( C / {C}_{eq} )} ) exp ( - \frac{1}{2 β * Zt} ) \qquad ( 17 )$$

where N is the precipitate density (number of precipitates per unit volume), N₀ is the number of atoms per unit volume (=1/Vₐₜₒₘ) and Z is Zeldovich's factor (≈1/20). The evolution of the precipitate size is calculated by:

$$\frac{d {r}_{eq}}{d t} = \frac{D}{{r}_{eq}} \frac{C - {C}_{eq} exp ( {r}_{0} / {r}_{eq } )}{1 - {C}_{eq} exp ( {r}_{0} / {r}_{eq } )} + \frac{1}{N} \frac{d N}{d t} ( α \frac{{r}_{0}}{ln ( C / {C}_{eq} )} - {r}_{eq} ) \qquad ( 18 )$$

where D is the diffusion coefficient of solute atom in solvent.

In the late stages of precipitation, the precipitates continue growing and coarsening, while the nucleation rate decreases significantly due to the desaturation of solid solution. When the mean precipitate size is much larger than the critical radius, it is valid to consider growth only. When the mean radius and the critical radius are equal, the conditions for the standard Lifshitz-Slyozov-Wagner (LSW) law are fulfilled. Under the LSW law, the radius of a growing particle is a function of t^{1/3} (where t is the time). The precipitate radius can be calculated by:

$${r}_{eq}^{3} - {r}_{0}^{3} = \frac{8}{9} \frac{D {C}_{o} γ {V}_{atom}^{2} t}{RT} \qquad ( 19 )$$

Several assumptions are made in calculating the particle spacing along the dislocation line. First, a steady state number of precipitates along the moving dislocation line is assumed, following Friedel's statistics for low obstacle strengths. After assuming a steady state number of precipitates, the precipitate spacing is then given by the calculation of the dislocation curvature under the applied resolved shear stress, τ on the slip plane:

$$l = {( \frac{4 π}{3 {f}_{v}} \frac{\overline{{r}_{eq}^{2}} Γ}{b τ} )}^{1 / 3} \qquad ( 20 )$$

where fᵥ is the volume fraction of precipitates and r̅_̅{̅e̅q̅}̅ is the average radius of precipitates. Γ is the line tension (=βμb², where β is a parameter close to 1/2).

The volume fraction of precipitates (fᵥ) can be determined experimentally by Transmission Electron Microscopy (TEM) or the Hierarchical Hybrid Control (HHC) model. In the HHC model, the volume fraction of precipitates can be calculated:

$${f}_{v} = \frac{2 π {r}_{eq}^{2}}{α} {A}_{0} {N}_{0} Z {β}^{*} exp ( \frac{- Δ G *}{RT} ) t \qquad ( 21 )$$

where α is the aspect ratio of precipitates, A₀ is the Avogadro number, ΔG* is the critical activation energy for precipitation, the parameter of β* is obtained by

β*=4π(r_{eq}*)²DC₀/a⁴ (22)

where a is the lattice parameter of precipitate.

In computational thermodynamics approaches, a commercially available aluminum database, for instance Pandat®, is employed to calculate precipitate equilibriums, such as β phase in Al—Si—Mg alloy and θ phase in Al—Si—Mg—Cu alloy. The equilibrium phase fractions, or the atomic % solute in the hardening phases are parameterized from computational thermodynamics calculations. The equilibrium phase fractions are dependent upon temperature and solute concentration, but independent of aging time (fᵢ^{eq}(T,C)).

Many metastable precipitate phases, such as β″, β′ in Al—Si—Mg alloy and θ′ in Al—Si—Mg—Cu alloy are absent from the existing computational thermodynamics database. The computational thermodynamics calculations alone cannot deliver the values of metastable phase fractions. In this case, the density-functional based first-principles methods are adopted to produce some properties such as energetics, which are needed by computational thermodynamics. Density functional theory (DFT) is a quantum mechanical theory commonly used in physics and chemistry to investigate the ground state of many-body systems, in particular atoms, molecules and the condensed phases. The main idea of DFT is to describe an interacting system of fermions via its density and not via its many-body wave function. First-principles methods, also based on quantum-mechanical electronic structure theory of solids, produce properties such as energetics without reference to any experimental data. The free energies of metastable phases can be described by a simple linear functional form:

ΔGᵢ(T)=c₁+c₂T (23)

where c₁ and c₂ are coefficients. c₁ is equivalent to enthalpies of formation of metastable phases at absolute zero temperature (T=0 K). By replacing the unknown parameter c₁ in Eqn. 14 with the formation enthalpy at T=0 K from first-principles, the free energy can be rewritten as

ΔGᵢ(T)=ΔHᵢ(T=0K)+c₂T (24)

The other unknown parameter c₂ can then be determined simply by fitting the free energies of liquid and solid to be equal at the melting point.

After calculating the strength increase due to precipitation hardening (Δσₚₚₜ), the yield strength of aluminum alloys can be simply calculated by adding it to the intrinsic strength (σᵢ) and the solid-solution strength of the material:

σ_{ys}=σᵢ+σₛₛ+Δσₚₚₜ (25)

The solid solution contribution to the yield strength is calculated as:

σₛₛ=KC_{GP/ss}^{2/3} (26)

where K is a constant and C_{GP/ss} is the concentration of strengthening solute that is not in the precipitates. The intrinsic strength (σᵢ) includes various strengthening effects such as grain/cell boundaries, the eutectic particles (in cast aluminum alloys), the aluminum matrix, and solid-solution strengthening due to alloying elements other than elements in precipitates.

Referring next to FIG. 5, a comparison between the predicted tensile stress-strain curves with experimental data of an aluminum alloy is shown. The predictions based on above constitutive models are in very good agreement with actual material behavior.

Regarding the determination of an in-service transient temperature distribution, the material constitutive models are coupled in an FEA analysis (for example, Abaqus FEA or the like) using a particular material's subroutine (such as UMAT in Abaqus FEA) to provide a user-defined mechanical behavior of a particular material. Significantly, such a material subroutine will be helpful in that it may be called at all material calculation nodal points for which the material definition includes time-dependent material behavior, and may use solution-dependent variables. Moreover, such a subroutine can be used to update stresses and solution-dependent state variables to their values at the end of the particular time increment for which the subroutine is called as a way to provide a material matrix (for example, a Jacobian matrix) for the constitutive model.

Referring next to FIG. 6, a flow chart of such a materials subroutine (such as the UMAT step 150 discussed above) is shown. In starting the routine, material model constants 200 are first set, after which a trial calculation 210 with elasticity equations is performed. From this, a flow stress 220 based on the material model is run, which allows a determination 230 of whether a Von Mises yield condition is met: if no, then the routine updated the state variables 280 and then ends; if yes, then alloy plasticity must be assumed and the corresponding plastic flow 240 must be calculated. From this, an equivalent plastic strain and hardening rate 250 of the alloy must be determined. Furthermore, the Jacobian displacement and velocity gradient matrices 260 are then determined for alloy plasticity, which are then used to make a final calculation 270 before state variable updating 280. In particular, the flow chart gives an example of how the material constitutive models are implemented in an FEA analysis. For example, in an FEA analysis using Abaqus FEA, the constitutive model is written in the aforementioned UMAT. To run the constitutive model, the model coefficients and constant values need to be given first. The first calculation 210 assumes elastic deformation (which is shown in Eqn. 28 below) in every node. The second calculation 220 uses the UMAT model to calculate current actual yield stress of the material in each node. The Von Mises stress (shown below in Eqn. 29), which is the combined stresses from six components (three each of tensile and shear stresses), is calculated in the first calculation 210 assuming elastic deformation is larger than the current material yield (flow) stress from the second calculation 220; from this, the FEA code will perform a plastic flow calculation 240 (Eqn. 30) and obtain equivalent plastic strain and hardening rate 250 (Eqn. 31) as well as stresses in six components for each node (Eqns. 32 through 34). The FEA code then generates a Jacobian matrix 260 to integrate all nodes for a plasticity calculation in order to figure out stresses and plastic deformation for each node and then to integrate all nodes into a single system (Eqn. 35).

In structural durability analysis, the FEA code (for instance the aforementioned Abaqus FEA) chooses a proper time increment for each step and calls the materials subroutine for calculating thermal strains and stresses at each integration point. The strain increments at integration points of each element are calculated from the temperature change and geometry structure based on the assumption of zero plastic strains. The equivalent strain increment at each integration point is calculated. The strain rate is then calculated based on the strain change at each time step.

$$d \overline{ɛ} = \frac{\sqrt{2}}{3} \sqrt{{( d {ɛ}_{11} - d {ɛ}_{22} )}^{2} + {( d {ɛ}_{11} - d {ɛ}_{33} )}^{2} + {( d {ɛ}_{22} - d {ɛ}_{33} )}^{2} + 6 * d {ɛ}_{12}^{2} + 6 * d {ɛ}_{23}^{2} + 6 * d {ɛ}_{13}^{2}} \dot{ɛ} = \frac{d \overline{ɛ}}{d t} \qquad ( 27 )$$

where dεᵢⱼ is one of the six components of strain increment for each integration point, and dt is time increment.

The trial elastic stress is calculated based on the fully elastic strains passed in from the main routine (such as Abaqus FEA),

δᵢⱼ=λδᵢⱼε^{el}ₖₖ+2με^{el}ₖₖ (28)

where ε^{el}ₖₖ is the driving variable, which is calculated by the main routine from the temperature change and geometry structure and passed into the user-defined materials subroutine. From this, the Von Mises stress based on purely elastic behavior is calculated:

$$\begin{matrix}\overline{σ} = \sqrt{\frac{1}{2} ( \begin{matrix}{( {σ}_{11} - {σ}_{22} )}^{2} + {( {σ}_{11} - {σ}_{33} )}^{2} + {( {σ}_{22} - {σ}_{33} )}^{2} + \\ 6 * {σ}_{12}^{2} + 6 * {σ}_{23}^{2} + 6 * {σ}_{13}^{2}\end{matrix} )} \\ = \sqrt{\frac{3}{2} {S}_{ij} {S}_{ij}} \\ = \sqrt{\frac{3}{2} ( {( {S}_{11} )}^{2} + {( {S}_{33} )}^{2} + {( {S}_{22} )}^{2} + 2 * {S}_{12}^{2} + 2 * {S}_{23}^{2} + 2 * {S}_{13}^{2} )}\end{matrix} \\ where \text{:} {S}_{ij} = {S}_{ij} - \frac{1}{3} {δ}_{ij} {σ}_{kk} \qquad ( 29 )$$

If the predicted elastic stress is larger than the current yield stress, plastic flow occurs.

$${\dot{ɛ}}_{ij}^{pl} = \frac{3 {S}_{ij}}{2 {σ}_{y}} {\dot{\overline{ɛ}}}^{pl} \qquad ( 30 )$$

The backward Euler method is used to integrate the equations for the calculation of plastic strain.

σ̅^{pr}−3μΔ ε̅^{pl}=σ_{y}( ε̅^{pl}) (31)

After above equation is solved, the actual plastic strain is determined. The stresses and strains are updated using the following equations.

$$\begin{matrix}{σ}_{ij} = {η}_{ij} {σ}_{y} + \frac{1}{3} {δ}_{ij} {σ}_{kk}^{pr} & ( 32 ) \\ {Δɛ}_{ij}^{pl} = \frac{3}{2} {η}_{ij} Δ {\overline{ɛ}}^{pl} & ( 33 ) \\ {η}_{ij} = \frac{{S}_{ij}^{pr}}{{\overline{σ}}^{pr}} & ( 34 )\end{matrix}$$

From this, the Jacobian Matrix at each integration point is calculated to solve plasticity equations.

$$Δ {\dot{σ}}_{ij} = {λ}^{*} {δ}_{ij} Δ {\dot{ɛ}}_{kk} + 2 {μ}^{*} Δ {\dot{ɛ}}_{ij} + ( \frac{h}{1 + h / 3 μ} - 3 {μ}^{*} ) {η}_{ij} {η}_{kl} Δ {\dot{ɛ}}_{kl} \\ where {μ}^{*} = {μσ}_{y} / {\overline{σ}}^{pr} , {λ}^{*} = k - \frac{2}{3} {μ}^{*} , and h = d {σ}_{y} / d {\overline{ɛ}}^{pl} . \qquad ( 35 )$$

Significantly, a time-independent plastic model only considers the plastic strain hardening, while creep law describes continuous straining while the stress is kept constant (or conversely, relaxation while strain is kept constant). As mentioned above, the method of the present invention includes a precipitation hardening/softening term in the viscoplastic model that makes it possible to account for material property changes when the component is subjected to elevated temperatures in a manner analogous to a continuous aging process.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “device” is utilized herein to represent a combination of components and individual components, regardless of whether the components are combined with other components. Likewise, a vehicle as understood in the present context includes numerous self-propelled variants, including a car, truck, aircraft, spacecraft, watercraft or motorcycle.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A method of computationally simulating material property changes in an aluminum alloy cast component, said method comprising
configuring a computer system to comprise a data input, a data output, at least one processing unit and at least one of data-containing memory and instruction-containing memory that are cooperative with one another through a data communication path;
receiving as input to said computer system nodal coordinate information corresponding to a geometric shape of said component;
receiving as input to said computer system material property information from a material property database that corresponds to said alloy;
receiving as input to said computer system time-dependent temperature information corresponding to at least one environmental condition that is expected to be encountered during operation of said component; and
determining material property changes of said component over time at each of said nodal coordinates through an algorithm that is based on at least one constitutive relationship and said time-dependent temperature information.

2. The method of claim 1, wherein said time-dependent temperature information is calculated based on a viscoplastic model.

3. The method of claim 2, wherein said viscoplastic model includes at least one of a precipitation hardening term and a precipitation softening term as a way to quantify said time-dependent temperature information.

4. The method of claim 3, wherein said at least one of a precipitation hardening term and a precipitation softening term of said viscoplastic model are quantified in the following equation:
$$\frac{σ}{μ ( T )} = {C}_{e} ( \dot{ɛ} , T ) \frac{{\hat{σ}}_{e}}{{μ}_{0}} + {C}_{p} ( \dot{ɛ} , T ) \frac{{\hat{σ}}_{p}}{{μ}_{0}} + {C}_{ppt} ( \dot{ɛ} , T ) \frac{{\hat{σ}}_{ppt}}{{μ}_{0}}$$
where Cₑ(\dot{ε},T), Cₚ(\dot{ε},T) and Cₚₚₜ(\dot{ε},T) are referred to as velocity-modified temperature-dependent coefficients, shear modulus μ₀, strain rate ε and temperature-dependent shear modulus μ(T).

5. The method of claim 2, wherein said viscoplastic model comprises at least one of a flow rule, drag stress evolution factor and a back stress evolution factor.

6. The method of claim 5, wherein said viscoplastic model is configured to determine at least one of cyclic thermal-mechanical inelastic deformation behavior, cyclic softening, thermal exposure, phase transformation and microstructure variations.

7. The method of claim 1, wherein functions associated with said constitutive relationship are selected from the group consisting of temperature, time, microstructure variation, strain and strain rate.

8. The method of claim 7, wherein factors used in said material constitutive relationship are selected from the group consisting of strain hardening, creep, precipitation hardening and precipitation softening.

9. The method of claim 7, wherein said strain is selected from the group consisting of elastic strain, plastic strain, creep strain and those due to thermal exposure.

10. The method of claim 9, wherein said plastic strain is determined by a time-independent plastic model.

11. The method of claim 9, wherein said creep strain is based upon either continuous straining while an applied stress is kept substantially constant, or under stress relaxation while said strain is kept substantially constant.

12. The method of claim 1, further comprising outputting said determined material property changes to a user-ready format.

13. A method of conducting a material property analysis for a cast aluminum alloy component, said method comprising:
configuring a computer to comprise a data input, a data output, a processing unit, a memory unit and a communication path for cooperation between said data input, said data output, said processing unit and said memory unit; and
accepting into said computer nodal information corresponding to a geometric representation of said component;
accepting into said computer material property information from a material property database;
accepting into said computer time-dependent temperature information corresponding to said component over its expected service life;
using an algorithm that is cooperative with said computer to determine material property changes of said component over time at each nodal coordinate, said algorithm comprising at least one constitutive relationship that is cooperative with said time-dependent temperature information; and
assigning at least one updated material property to each nodal coordinate within said geometric representation of said component based on said changes determined by said algorithm.

14. The method of claim 13, wherein said configuring said computer comprises operating said computer with a plurality of computation modules programmably cooperative with at least one of said memory unit and said processing unit such that upon receipt of information pertaining to said component, said computer subjects said information to said plurality of computation modules such that output therefrom provides said updated material property.

15. The method of claim 13, wherein said time-dependent temperature information is calculated based on a viscoplastic model.

16. The method of claim 15, wherein said viscoplastic model includes at least one of a precipitation hardening term and a precipitation softening term as a way to quantify said time-dependent temperature information.

17. The method of claim 15, wherein said at least one of a precipitation hardening term and a precipitation softening term of said viscoplastic model are quantified in the following equation:
$$\frac{σ}{μ ( T )} = {C}_{e} ( \dot{ɛ} , T ) \frac{{\hat{σ}}_{e}}{{μ}_{0}} + {C}_{p} ( \dot{ɛ} , T ) \frac{{\hat{σ}}_{p}}{{μ}_{0}} + {C}_{ppt} ( \dot{ɛ} , T ) \frac{{\hat{σ}}_{ppt}}{{μ}_{0}}$$
where Cₑ(\dot{ε},T), Cₚ(\dot{ε},T) and Cₚₚₜ(\dot{ε},T) are referred to as velocity-modified temperature-dependent coefficients, shear modulus μ₀, strain rate ε and temperature-dependent shear modulus μ(T).

18. An article of manufacture comprising a computer usable medium having computer readable program code embodied therein for predicting time-dependent material properties of a cast aluminum alloy component, said computer readable program code in said article of manufacture comprising:
computer readable program code portion for causing said computer to accept nodal information corresponding to a geometric representation of said component;
computer readable program code portion for causing said computer to accept material property information for an aluminum alloy material that corresponds to said component; and
computer readable program code portion for causing said computer to use said material property information, time-dependent temperature information and at least one constitutive equation to approximate updated material properties at each of a plurality of nodal coordinates of said component that accept said nodal information.

19. The article of manufacture of claim 18, further comprising computer readable program code portion for causing said computer to map values of said updated material properties to a user-ready format.

20. The article of manufacture of claim 18, wherein said computer readable program code portion for causing said computer to use said at least one constitutive equation comprises causing said computer to base said at least one constitutive equation on a viscoplastic model that includes at least one of a precipitation hardening term and a precipitation softening term as a way to quantify said time-dependent temperature information.
